(19) United States
(12) Patent Application Publication
(10) Pub. No.: US 2015/0226547 A1
(43) Pub. Date: Aug. 13, 2015

(54) METHOD OF ALIGNING TRANSPARENT SUBSTRATES USING MOIRÉ INTERFERENCE

(71) Applicant: Uni-Pixel Displays, Inc., The Woodlands, TX (US)

(72) Inventor: Kevin J. Derichs, Buda, TX (US)

(73) Assignee: Uni-Pixel Displays, Inc., The Woodlands, TX (US)

(21) Appl. No.: 14/177,091

(22) Filed: Feb. 10, 2014

(51) Int. Cl. G01B 11/27; B32B 38/18; B32B 37/12; B32B 37/18

(52) U.S. Cl. CPC G01B 11/272; B32B 37/18; B32B 38/18; B32B 37/12; B32B 2307/412; B32B 2309/06; B32B 2551/00

(57) ABSTRACT

A method of aligning transparent substrates includes disposing one or more Moiré interference patterns on a side of a first transparent substrate, disposing one or more inverted Moiré interference patterns on a side of a second transparent substrate, and aligning the first transparent substrate to the second transparent substrate using Moiré interference. Each Moiré interference pattern is center-aligned to a corresponding inverted Moiré interference pattern.

### BACKGROUND OF THE INVENTION

A touch screen enabled system allows a user to control various aspects of the system by touch or gestures. For example, a user may interact directly with objects depicted on a display device by touch or gestures that are sensed by a touch sensor. The touch sensor typically includes a pattern of conductive lines disposed on a substrate configured to sense touch.

Touch screens are commonly found in consumer systems, commercial systems, and industrial systems including, but not limited to, smartphones, tablet computers, laptop computers, desktop computers, printers, monitors, televisions, appliances, kiosks, copiers, desktop phones, automotive display systems, portable gaming devices, and gaming consoles.

### BRIEF SUMMARY OF THE INVENTION

According to one aspect of one or more embodiments of the present invention, a method of aligning transparent substrates includes disposing one or more Moiré interference patterns on a side of a first transparent substrate, disposing one or more inverted Moiré interference patterns on a side of a second transparent substrate, and aligning the first transparent substrate to the second transparent substrate using Moiré interference. Each Moiré interference pattern is center-aligned to a corresponding inverted Moiré interference pattern.

According to one aspect of one or more embodiments of the present invention, a method of aligning conductive patterns disposed on transparent substrates includes disposing a first conductive pattern and one or more Moiré interference patterns on a side of a first transparent substrate, disposing a second conductive pattern and one or more inverted Moiré interference patterns on a side of a second transparent substrate, and aligning the first transparent substrate to the second transparent substrate using Moiré interference. Each Moiré interference pattern is center-aligned to a corresponding inverted Moiré interference pattern.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled computing system in accordance with one or more embodiments of the present invention.

FIG. 3 shows a functional representation of a touch sensor as part of a touch screen in accordance with one or more embodiments of the present invention.

FIG. 4A shows a cross-section of a touch sensor with a first conductive pattern disposed on a first transparent substrate and a second conductive pattern disposed on a second transparent substrate in accordance with one or more embodiments of the present invention.

FIG. 4B shows a cross-section of a touch sensor with a first conductive pattern disposed on a first transparent substrate and a second conductive pattern disposed on a second transparent substrate in accordance with one or more embodiments of the present invention.

FIG. 4C shows a cross-section of a touch sensor with a first conductive pattern disposed on a first transparent substrate and a second conductive pattern disposed on a second transparent substrate in accordance with one or more embodiments of the present invention.

FIG. 5 shows a first conductive pattern disposed on a first transparent substrate in accordance with one or more embodiments of the present invention.

FIG. 6 shows a second conductive pattern disposed on a second transparent substrate in accordance with one or more embodiments of the present invention.

FIG. 7 shows a portion of a touch sensor in accordance with one or more embodiments of the present invention.

FIG. 8A shows a Moiré interference pattern in accordance with one or more embodiments of the present invention.

FIG. 8B shows an inverted Moiré interference pattern in accordance with one or more embodiments of the present invention.

FIG. 9A shows a Moiré interference pattern and an inverted Moiré interference pattern that do not overlap in accordance with one or more embodiments of the present invention.

FIG. 9B shows a Moiré interference pattern that partially overlaps an inverted Moiré interference pattern in accordance with one or more embodiments of the present invention.

FIG. 9C shows a Moiré interference pattern that substantially overlaps an inverted Moiré interference pattern in accordance with one or more embodiments of the present invention.

FIG. 9D shows a Moiré interference pattern that overlaps and is center-aligned to an inverted Moiré interference pattern in accordance with one or more embodiments of the present invention.

FIG. 10A shows a first conductive pattern and a plurality of Moiré interference patterns disposed on a first transparent substrate in accordance with one or more embodiments of the present invention.

FIG. 10B shows a second conductive pattern and a plurality of inverted Moiré interference patterns disposed on a second transparent substrate in accordance with one or more embodiments of the present invention.

FIG. 11 shows a first conductive pattern and a plurality of Moiré interference patterns disposed on a first transparent substrate that partially overlaps a second conductive pattern and a plurality of inverted Moiré interference patterns disposed on a second transparent substrate in accordance with one or more embodiments of the present invention.

FIG. 12 shows a first conductive pattern and a plurality of Moiré interference patterns disposed on a first transparent substrate that substantially overlaps a second conductive pattern and a plurality of inverted Moiré interference patterns disposed on a second transparent substrate in accordance with one or more embodiments of the present invention.

FIG. 13 shows a first conductive pattern and a plurality of Moiré interference patterns disposed on a first transparent substrate that overlaps and is aligned to a second conductive pattern and a plurality of inverted Moiré interference patterns disposed on a second transparent substrate in accordance with one or more embodiments of the present invention.

FIG. 14A shows a Moiré interference pattern and an inverted Moiré interference pattern that do not overlap in accordance with one or more embodiments of the present invention.

FIG. 14B shows a Moiré interference pattern that partially overlaps an inverted Moiré interference pattern in accordance with one or more embodiments of the present invention.

FIG. 14C shows a Moiré interference pattern that substantially overlaps an inverted Moiré interference pattern in accordance with one or more embodiments of the present invention.

FIG. 14D shows a Moiré interference pattern that overlaps and is center-aligned to an inverted Moiré interference pattern in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

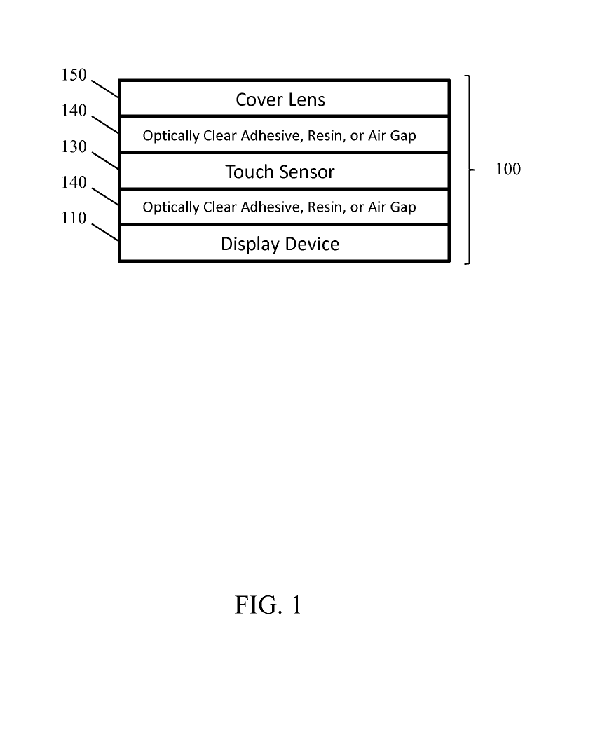

FIG. 1 shows a cross-section of a touch screen 100 in accordance with one or more embodiments of the present invention. Touch screen 100 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, a touch sensor 130 may overlay display device 110. In certain embodiments, an optically clear adhesive or resin 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110. A cover lens 150 may overlay touch sensor 130. Cover lens 150 may be composed of glass, plastic, film, or other material. In certain embodiments, an optically clear adhesive or resin 140 may bond a bottom side of cover lens 150 to a top, or user-facing, side of touch sensor 130. In other embodiments, an isolation layer, or air gap, 140 may separate the bottom side of cover lens 150 and the top, or user-facing, side of touch sensor 130. A top side of cover lens 150 faces the user and protects the underlying components of touch screen 100. One of ordinary skill in the art will recognize that other embodiments, including those where a touch sensor is integrated into a display device stack, may be used in accordance with one or more embodiments of the present invention. One of ordinary skill in the art will also recognize that touch sensor 130 may be a capacitive, resistive, optical, or acoustic touch sensor including, for example, a touch sensor that includes a flexographically printed and electroless plated conductive pattern or a touch sensor that includes an indium tin oxide (“ITO”) conductive pattern in accordance with one or more embodiments of the present invention.

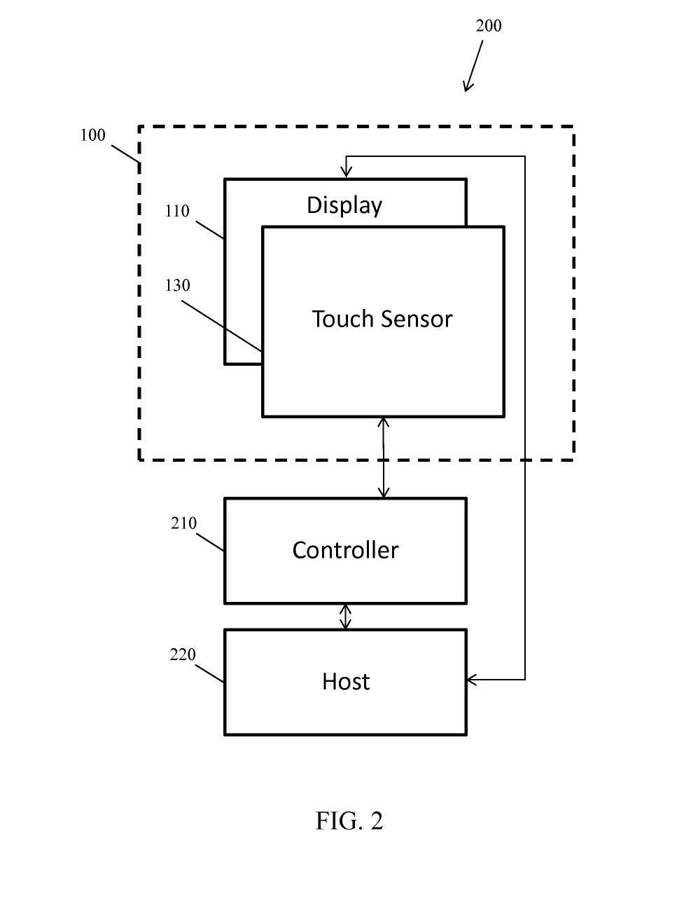

FIG. 2 shows a schematic view of a touch screen 100 enabled computing system 200 in accordance with one or more embodiments of the present invention. Computing system 200 may be a consumer computing system, commercial computing system, or industrial computing system including, but not limited to, smartphones, tablet computers, laptop computers, desktop computers, printers, monitors, televisions, appliances, kiosks, copiers, desktop phones, automotive display systems, portable gaming devices, gaming consoles, or other applications or designs suitable for use with touch screen 100.

Computing system 200 may include one or more printed or flex circuits (not shown) on which one or more processors (not shown) and system memory (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). Computing system 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including network-attached storage devices and cloud-based storage devices.

In certain embodiments, touch screen 100 may include display device 110 and touch sensor 130 that overlays at least a portion of a viewable area of display device 110. In other embodiments (not shown), touch sensor 130 may be integrated into display device 110. Controller 210 electrically drives at least a portion of touch sensor 130. Touch sensor 130 senses touch (capacitance, resistance, optical, or acoustic) and conveys information corresponding to the sensed touch to controller 210. In typical applications, the manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with computing system 200 by touch or gestures on touch screen 100. In certain embodiments, host 220 may be the one or more printed or flex circuits (not shown) on which the one or more processors (not shown) are disposed. In other embodiments, host 220 may be a subsystem or any other part of computing system 200 that is configured to interface with display device 110 and controller 210.

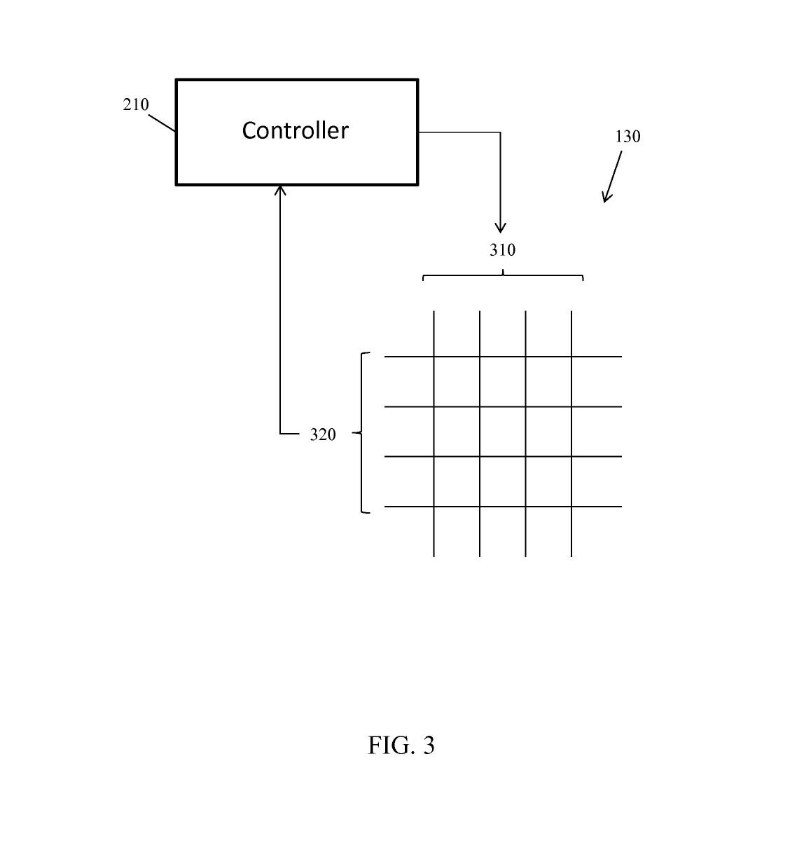

FIG. 3 shows a functional representation of a touch sensor 130 as part of a touch screen 100 in accordance with one or more embodiments of the present invention. In certain embodiments, touch sensor 130 may be viewed as a plurality of column lines 310 and a plurality of row lines 320 arranged as a mesh grid. The number of column lines 310 and the number of row lines 320 may not be the same and may vary based on an application or a design. The apparent intersections of column lines 310 and row lines 320 may be viewed as uniquely addressable locations of touch sensor 130. In operation, controller 210 may electrically drive one or more row lines 320 and touch sensor 130 may sense touch on one or more column lines 310 sampled by controller 210. One of ordinary skill in the art will recognize that the role of column lines 310 and row lines 320 may be reversed such that controller 210 electrically drives one or more column lines 310 and touch sensor 130 senses touch on one or more row lines 320 sampled by controller 210.

In certain embodiments, controller 210 may interface with touch sensor 130 by a scanning process. In such an embodiment, controller 210 may electrically drive a selected row line 320 (or column line 310) and sample all column lines 310 (or row lines 320) that intersect the selected row line 320 (or column line 310) by measuring, for example, capacitance at each intersection. This process may be continued through all row lines 320 (or all column lines 310) such that capacitance is measured at each uniquely addressable location of touch sensor 130 at predetermined intervals. Controller 210 may allow for the adjustment of the scan rate depending on the needs of a particular design or application. One of ordinary skill in the art will recognize that the scanning process discussed above may also be used with other touch sensor technologies, applications, or designs in accordance with one or more embodiments of the present invention.

In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

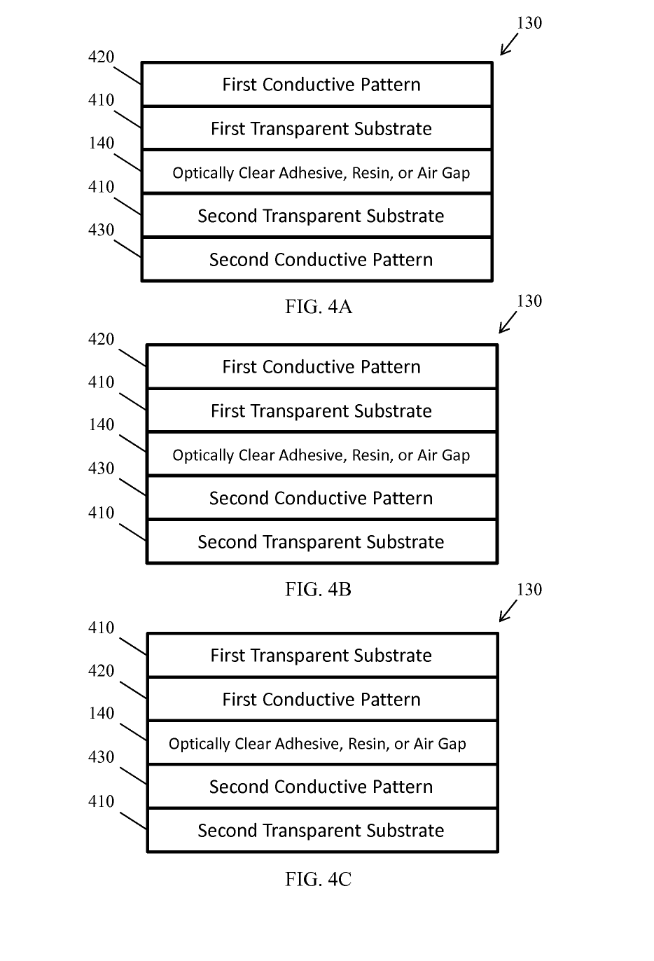

FIG. 4A shows a cross-section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on a top, or user-facing, side of first transparent substrate 410 and second conductive pattern 430 disposed on a bottom side of second transparent substrate 410. A bottom side of the first transparent substrate 410 may overlay a top side of the second transparent substrate 410 at a predetermined alignment. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 between the bottom side of the first transparent substrate 410 and the top side of the second transparent substrate 410.

FIG. 4B shows a cross-section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on a top, or user-facing, side of the first transparent substrate 410 and second conductive pattern 430 disposed on a top side of the second transparent substrate 410. A bottom side of the first transparent substrate 410 may overlay the second conductive pattern 430 disposed on the top side of the second transparent substrate 410 at a predetermined alignment. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 between the bottom side of the first transparent substrate 410 and the second conductive pattern 430 disposed on the top side of the second transparent substrate 410.

FIG. 4C shows a cross-section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on the bottom side of the first transparent substrate 410 and second conductive pattern 430 disposed on the top side of the second transparent substrate 410. The first conductive pattern 420 disposed on the bottom side of the first transparent substrate 410 may overlay the second conductive pattern 430 disposed on the top side of the second transparent substrate 410 at a predetermined alignment. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 between the first conductive pattern 420 disposed on the bottom side of the first transparent substrate 410 and the second conductive pattern 430 disposed on the top side of the second transparent substrate 410.

One of ordinary skill in the art will recognize that the disposition of the first conductive pattern and the second conductive pattern may be reversed in accordance with one or more embodiments of the present invention. One of ordinary skill in the art will also recognize that other stackups, including those that vary in the number, type, or organization of substrates and/or conductive pattern(s), if any, are within the scope of one or more embodiments of the present invention.

In certain embodiments, a conductive pattern (e.g., first conductive pattern 420 or second conductive pattern 430) may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing, including the flexographic printing of a catalytic ink that is metallized by an electroless plating process, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or UV-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means the transmission of visible light with a transmittance rate of 85% or more. In certain embodiments, transparent substrate 410 may be polyethylene terephthalate (“PET”), polyethylene naphthalate (“PEN”), cellulose acetate (“TAC”), cycloaliphatic hydrocarbons (“COP”), bi-axially-oriented polypropylene (“BOPP”), polyester, polycarbonate, glass, or combinations thereof. In other embodiments, transparent substrate 410 may be any other transparent material suitable for use as a substrate. One of ordinary skill in the art will recognize that the composition of transparent substrate 410 may vary based on an application or design in accordance with one or more embodiments of the present invention.

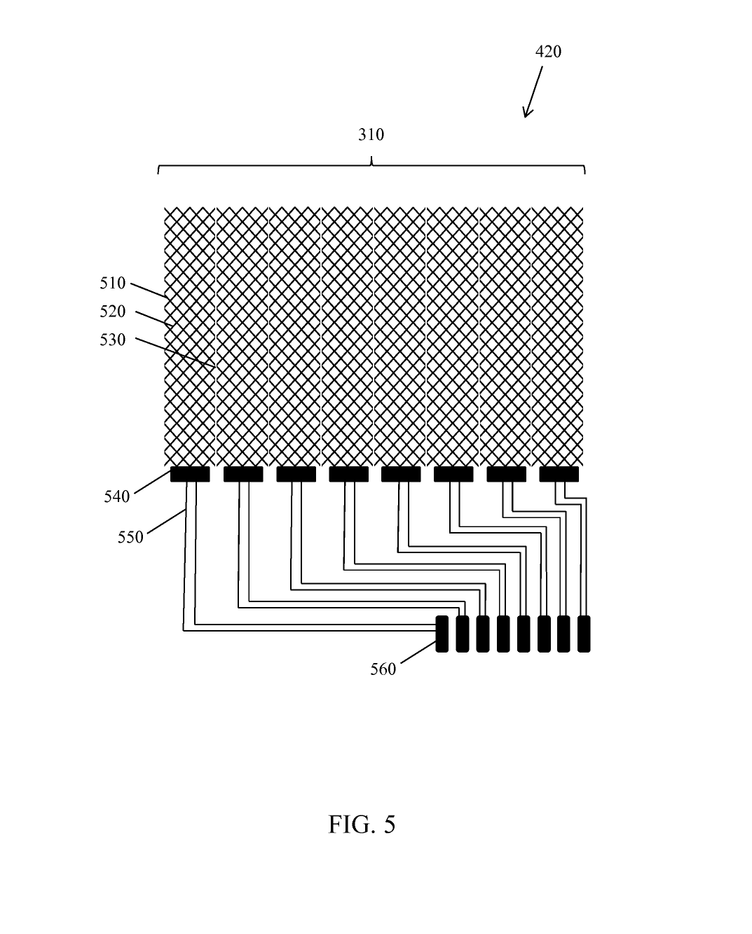

FIG. 5 shows a first conductive pattern 420 disposed on a transparent substrate (e.g., transparent substrate 410) in accordance with one or more embodiments of the present invention. In certain embodiments, first conductive pattern 420 may include a mesh formed by a plurality of parallel conductive lines oriented in a first direction 510 and a plurality of parallel conductive lines oriented in a second direction 520 that are disposed on a side of a first transparent substrate (e.g., transparent substrate 410). One of ordinary skill in the art will also recognize that a size of first conductive pattern 420 may vary based on an application or a design in accordance with one or more embodiments of the present invention. In other embodiments (not shown), first conductive pattern 420 may include any other pattern formed by one or more conductive lines or features. One of ordinary skill in the art will recognize that the composition of a conductive pattern may vary in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention. In other embodiments (not shown), a conductive pattern may include one or more conductive lines or features in any shape or pattern. One of ordinary skill in the art will also recognize that the composition of a conductive pattern may vary in accordance with one or more embodiments of the present invention.

In certain embodiments, a plurality of breaks 530 may partition first conductive pattern 420 into a plurality of column lines 310, each electrically partitioned from the others. Each column line 310 may route to a channel pad 540. Each channel pad 540 may route to an interface connector 560 by way of one or more interconnect conductive lines 550. Interface connectors 560 may provide a connection interface between the touch sensor (130 of FIG. 1) and the controller (210 of FIG. 2).

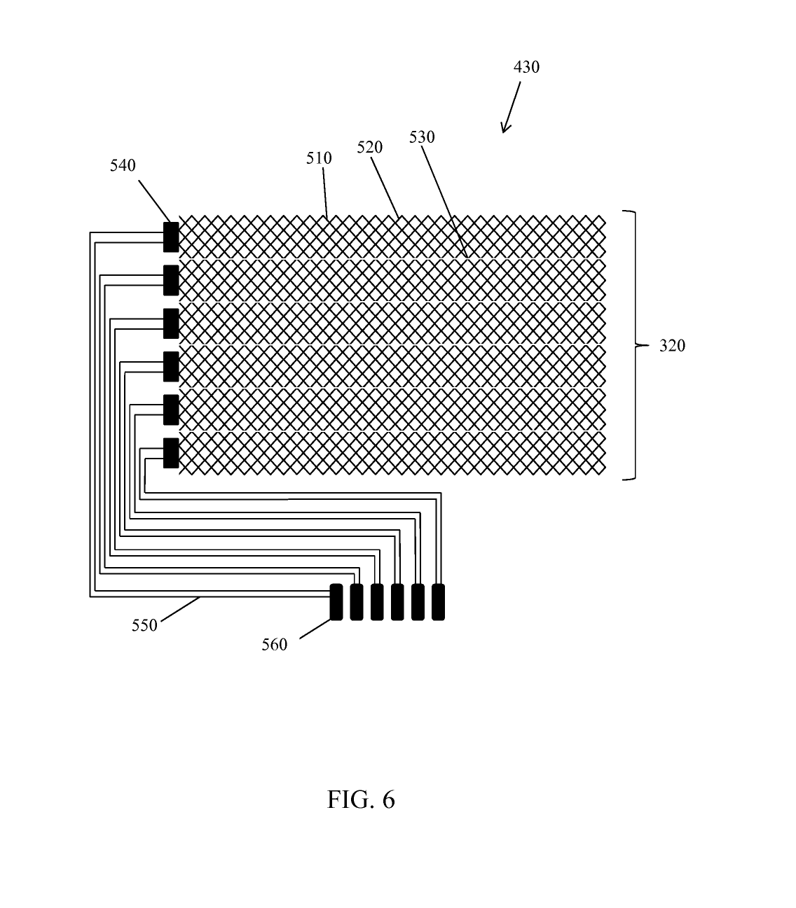

FIG. 6 shows a second conductive pattern 430 disposed on a second transparent substrate (e.g., transparent substrate 410) in accordance with one or more embodiments of the present invention. In certain embodiments, second conductive pattern 430 may include a mesh formed by a plurality of parallel conductive lines oriented in a first direction 510 and a plurality of parallel conductive lines oriented in a second direction 520 disposed on a side of a second transparent substrate (e.g., transparent substrate 410). In certain embodiments, the second conductive pattern 430 may be substantially similar in size to the first conductive pattern 420. One of ordinary skill in the art will recognize that a size of the second conductive pattern 430 may vary based on an application or a design in accordance with one or more embodiments of the present invention. In other embodiments (not shown), second conductive pattern 430 may include any other pattern formed by a plurality of conductive lines or features in any shape or pattern. One of ordinary skill in the art will recognize that the composition of a conductive pattern may vary in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention. In other embodiments (not shown), a conductive pattern may include one or more conductive lines or features in any shape or pattern. One of ordinary skill in the art will also recognize that a conductive pattern is not limited to sets of parallel conductive lines and could be any other shape or pattern, including predetermined or random orientations of line segments, curved line segments, conductive particles, polygons, or any other shape(s) or pattern(s) comprised of electrically conductive material in accordance with one or more embodiments of the present invention.

In certain embodiments, a plurality of breaks 530 may partition second conductive pattern 430 into a plurality of row lines 320, each electrically partitioned from the others. Each row line 320 may route to a channel pad 540. Each channel pad 540 may route to an interface connector 560 by way of one or more interconnect conductive lines 550. Interface connectors 560 may provide a connection interface between the touch sensor (130 of FIG. 1) and the controller (210 of FIG. 2).

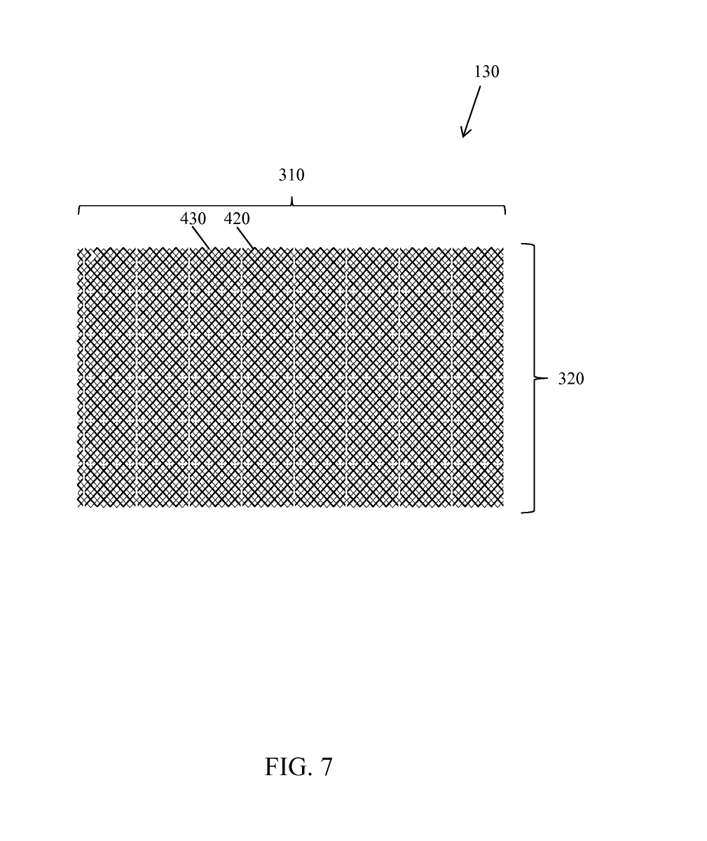

FIG. 7 shows a portion of a touch sensor 130 in accordance with one or more embodiments of the present invention. In certain embodiments, a touch sensor 130 may be formed, for example, by disposing a first conductive pattern 420 on a top, or user-facing, side of a first transparent substrate (e.g., transparent substrate 410) and disposing a second conductive pattern 430 on a bottom side of a second transparent substrate (e.g., transparent substrate 410). The first transparent substrate may overlay the second transparent substrate in a predetermined alignment that may include an offset (horizontal and/or vertical) depending on the application or design. The first transparent substrate may be bonded to the second transparent substrate by a lamination process, optically clear adhesive or resin, or the first transparent substrate and the second transparent substrate may be fixed in place and separated by an isolation layer or air gap. One of ordinary skill in the art will recognize that the first transparent substrate may be bonded to the second transparent substrate by other processes in accordance with one or more embodiments of the present invention.

In other embodiments, a touch sensor 130 may be formed, for example, by disposing a first conductive pattern 420 on a top, or user-facing, side of a first transparent substrate (e.g., transparent substrate 410) and disposing a second conductive pattern 430 on a top side of a second transparent substrate (e.g., transparent substrate 410). The first transparent substrate may overlay the second transparent substrate in a predetermined alignment that may include an offset (horizontal and/or vertical) depending on the application or design. The first transparent substrate may be bonded to the second transparent substrate by a lamination process, optically clear adhesive or resin, or the first transparent substrate and the second transparent substrate may be fixed in place and separated by an isolation layer or air gap. One of ordinary skill in the art will recognize that the first transparent substrate may be bonded to the second transparent substrate by other processes in accordance with one or more embodiments of the present invention.

In still other embodiments, a touch sensor 130 may be formed, for example, by disposing a first conductive pattern 420 on a bottom side of a first transparent substrate (e.g., transparent substrate 410) and disposing a second conductive pattern 430 on a top side of a second transparent substrate (e.g., transparent substrate 410). The first transparent substrate may overlay the second transparent substrate in a predetermined alignment that may include an offset (horizontal and/or vertical) depending on the application or design. The first transparent substrate may be bonded to the second transparent substrate by a lamination process, optically clear adhesive or resin, or the first transparent substrate and the second transparent substrate may be fixed in place and separated by an isolation layer or air gap. One of ordinary skill in the art will recognize that the first transparent substrate may be bonded to the second transparent substrate by other processes in accordance with one or more embodiments of the present invention. One of ordinary skill in the art will recognize that other touch sensor 130 stackups may be used in accordance with one or more embodiments of the present invention.

In certain embodiments, the first conductive pattern 420 may include a plurality of parallel conductive lines oriented in a first direction (510 of FIG. 5) and a plurality of parallel conductive lines oriented in a second direction (520 of FIG. 5) that form a mesh that is partitioned by a plurality of breaks (530 of FIG. 5) into electrically partitioned column lines 310. The second conductive pattern 430 may include a plurality of parallel conductive lines oriented in a first direction (510 of FIG. 6) and a plurality of parallel conductive lines oriented in a second direction (520 of FIG. 6) that form a mesh that is partitioned by a plurality of breaks (530 of FIG. 6) into electrically partitioned row lines 320. In operation, a controller (210 of FIG. 2) may electrically drive one or more row lines 320 (or column lines 310) and touch sensor 130 senses touch on one or more column lines 310 (or row lines 320) sampled by the controller (210 of FIG. 2). In other embodiments, the role of the first conductive pattern 420 and the second conductive pattern 430 may be reversed.

In certain embodiments, one or more of the plurality of parallel conductive lines oriented in a first direction (510 of FIG. 5 and FIG. 6), one or more of the plurality of parallel conductive lines oriented in a second direction (520 of FIG. 5 and FIG. 6), one or more of the plurality of breaks (530 of FIG. 5 and FIG. 6), one or more of the plurality of channel pads (540 of FIG. 5 and FIG. 6), one or more of the plurality of interconnect conductive lines (550 of FIG. 5 and FIG. 6), and/or one or more of the plurality of interface connectors (560 of FIG. 5 and FIG. 6) of the first conductive pattern 420 or second conductive pattern 430 may have different line widths and/or different orientations. In addition, the number of parallel conductive lines oriented in the first direction (510 of FIG. 5 and FIG. 6), the number of parallel conductive lines oriented in the second direction (520 of FIG. 5 and FIG. 6), and the line-to-line spacing between them may vary based on an application or a design. One of ordinary skill in the art will recognize that the size, configuration, and design of each conductive pattern may vary in accordance with one or more embodiments of the present invention.

In certain embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width less than approximately 5 micrometers. In other embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width in a range between approximately 5 micrometers and approximately 10 micrometers. In still other embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width in a range between approximately 10 micrometers and approximately 50 micrometers. In still other embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width greater than approximately 50 micrometers. One of ordinary skill in the art will recognize that the shape and width of one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may vary in accordance with one or more embodiments of the present invention.

When first conductive pattern 420 is disposed on a first transparent substrate (e.g., transparent substrate 410) and second conductive pattern 430 is disposed on a second transparent substrate (e.g., transparent substrate 410), the first transparent substrate may overlay the second transparent substrate such that the first conductive pattern 420 overlays and is aligned to the second conductive pattern 430 at a predetermined alignment that may include a predetermined offset (horizontal and/or vertical). The predetermined offset, which includes the option of no offset, may vary based on an application or design.

In certain embodiments, the first transparent substrate (e.g., transparent substrate 410) may be bonded to the second transparent substrate (e.g., transparent substrate 410) by a lamination process. In other embodiments, the first transparent substrate may be bonded to the second transparent substrate by an optically clear adhesive or resin. In still other embodiments, the first transparent substrate may be fixed in place and separated from the second transparent substrate by an isolation layer or air gap. Regardless of the method used, the first transparent substrate overlays the second transparent substrate such that the first conductive pattern 420 overlays and is aligned to the second conductive pattern 430 at a predetermined alignment that may include a predetermined offset that provides the desired sensing function of touch sensor 130. One of ordinary skill in the art will recognize that it is important to align the first transparent substrate to the second transparent substrate prior to bonding to ensure proper operation of touch sensor 130.

However, because the first conductive pattern 420 and the second conductive pattern 430 may each include a plurality of parallel conductive lines or features that are micrometer-fine, alignment of the first conductive pattern 420 to the second conductive pattern 430 at a predetermined alignment that may include a predetermined offset is complicated, time-consuming, and increases the cost associated with the manufacture of a touch sensor. In addition, failure to properly align the first conductive pattern 420 to the second conductive pattern 430 may render the touch sensor 130 inoperable for its intended purpose.

In one or more embodiments of the present invention, a method of aligning transparent substrates allows for the simple, effective, and cost-efficient alignment of transparent substrates, including embodiments where a first conductive pattern 420 disposed on a first transparent substrate (410 of FIG. 4) is aligned to a second conductive pattern 430 disposed on a second transparent substrate (410 of FIG. 4) at a predetermined alignment that may include a predetermined offset that provides the desired sensing function of touch sensor 130.

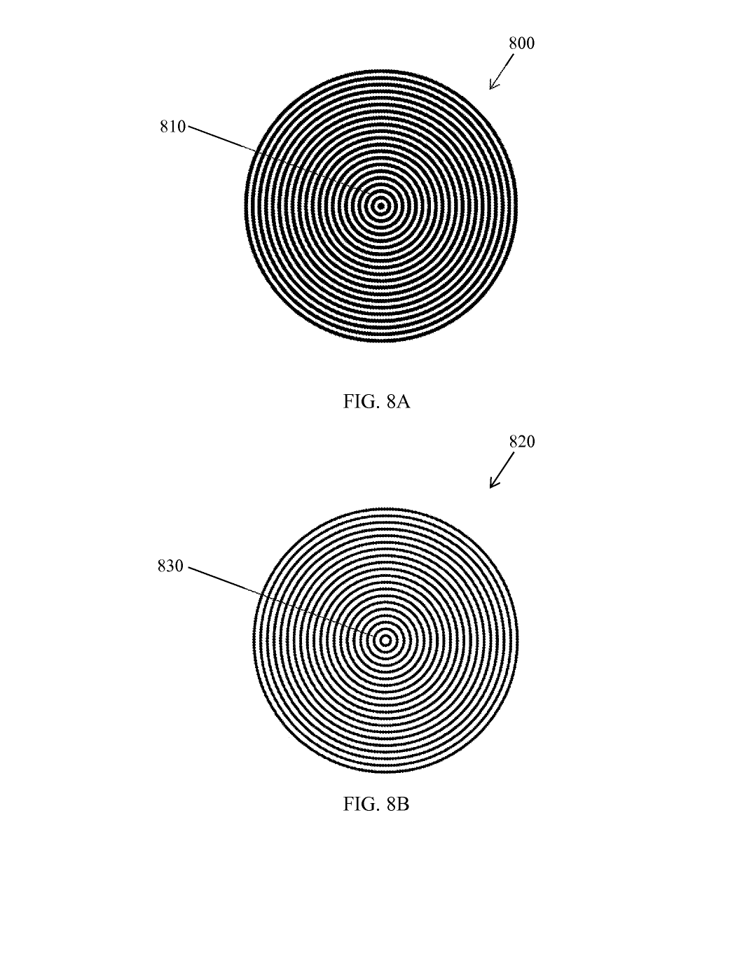

FIG. 8A shows a Moiré interference pattern 800 in accordance with one or more embodiments of the present invention. Moiré interference pattern 800 may be disposed on a transparent substrate (e.g., transparent substrate 410) using the same process or processes used to dispose a conductive pattern (e.g., 420 or 430 of FIG. 7) on the transparent substrate (e.g., transparent substrate 410). In certain embodiments, Moiré interference pattern 800 may be a plurality of concentric circles 810 that are opaque. The plurality of concentric circles 810 may be constructed by the following process. First, a maximum radius, MR, for the desired Moiré interference pattern 800 may be selected. Second, a maximum number of concentric circles, MN, may be selected. Third, a trace width, TW, for the concentric circles may be calculated by dividing the maximum radius, MR, by the quantity (2×MN). Fourth, a space width, SW, between adjacent concentric circles may be selected. The space width, SW, should be equal to, or slightly smaller than, the trace width, TW. The plurality of concentric circles 810 having the calculated trace width, TW, may be drawn using the following process. Draw a first circle with a radius equal to the maximum radius, MR. Draw a second circle with a radius equal to the difference between the maximum radius, MR, and the space width, SW. Draw a third circle with a radius equal to the difference between the second circle's radius and the trace width, TW. Draw a fourth circle with a radius equal to the difference between the third circle's radius and the space width, SW. Draw a fifth circle with a radius equal to the difference between the fourth circle's radius and the trace width, TW. The process of a drawing a subsequent circle with a radius equal to the difference between the previous circle's radius and either the space width, SW, or trace width, TW, may be repeated until the calculated radius is less than the trace width, TW.

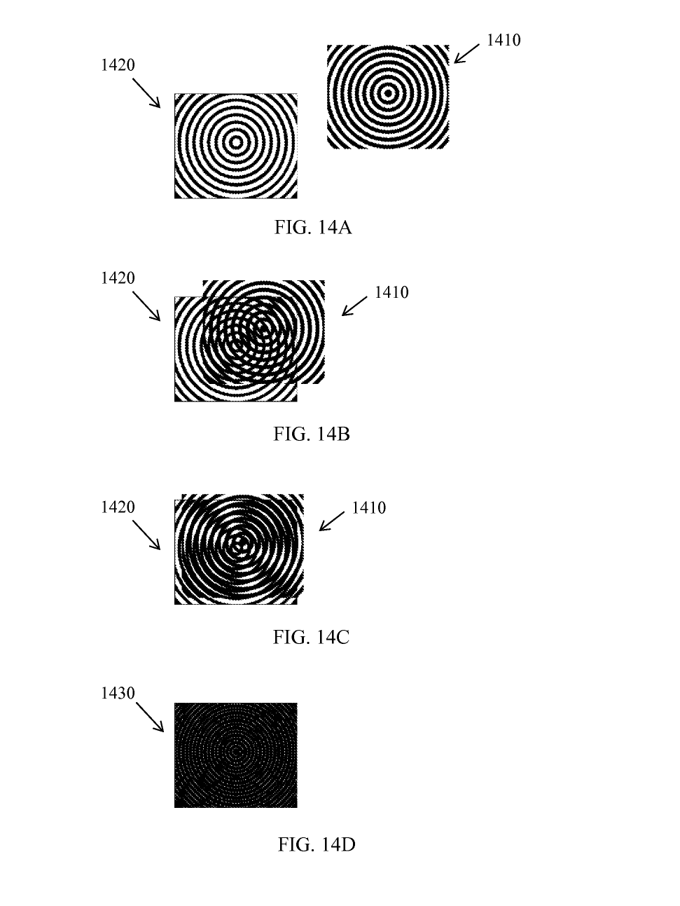

In other embodiments, Moiré interference pattern 800 may be a plurality of concentric circles 810 cropped into a box (1410 of FIG. 14) or any other shape container (not shown) required by an application or design. In still other embodiments, Moiré interference pattern 800 may be a Fresnel zone pattern. One of ordinary skill in the art will recognize that any pattern suitable for generating Moiré interference may be used in accordance with one or more embodiments of the present invention. One of ordinary skill in the art will also recognize that the type, shape, pattern, and size of Moiré interference pattern 800 may vary based on an application or design in accordance with one or more embodiments of the present invention.

FIG. 8B shows an inverted Moiré interference pattern 820 in accordance with one or more embodiments of the present invention. Inverted Moiré interference pattern 820 may be disposed on a transparent substrate (e.g., transparent substrate 410) using the same process or processes used to dispose a conductive pattern (e.g., 420 or 430 of FIG. 7) on the transparent substrate (e.g., transparent substrate 410). Inverted Moiré interference pattern 820 may be an inverted image of the corresponding Moiré interference pattern 800. As such, a plurality of concentric circles 830 of inverted Moiré interference pattern 820 correspond to the spaces, or non-patterned areas, between the plurality of concentric circles 810 of Moiré interference pattern 800.

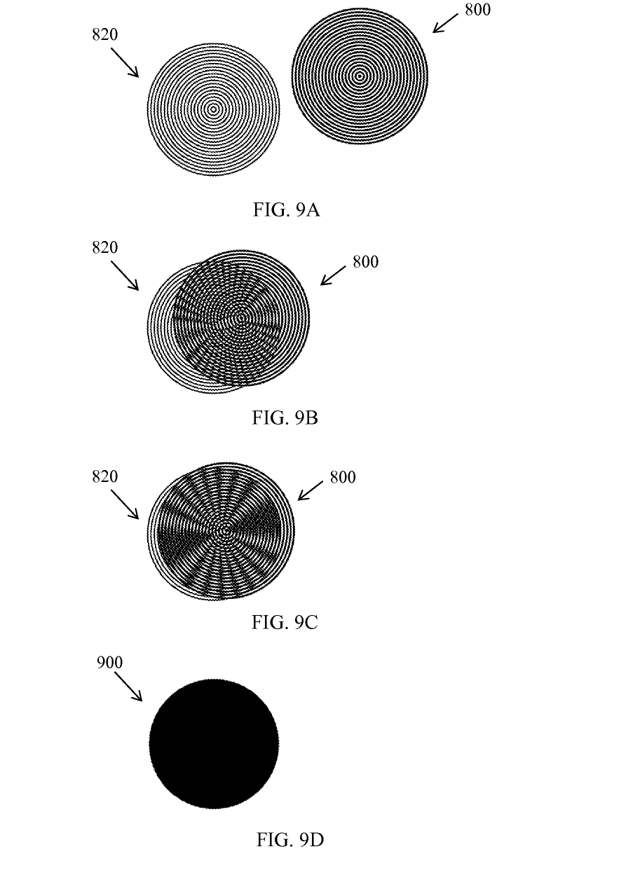

FIG. 9A shows a Moiré interference pattern 800 and an inverted Moiré interference pattern 820 that do not overlap in accordance with one or more embodiments of the present invention. Moiré interference pattern 800 may be disposed, for example, on a first transparent substrate (not independently illustrated) and inverted Moiré interference pattern 820 may be disposed, for example, on a second transparent substrate (not independently illustrated).

Continuing in FIG. 9B, Moiré interference pattern 800 partially overlaps inverted Moiré interference pattern 820. However, a center of Moiré interference pattern 800 is not aligned to a center of inverted Moiré interference pattern 820. Because Moiré interference pattern 800 is not center-aligned to inverted Moiré interference pattern 820, Moiré interference may be visually apparent. In this instance, the Moiré interference includes what appears to be an arrowhead effect that tends to point towards the centers of the patterns. The arrowhead effect may indicate a vector for further alignment in applications or designs that use automation. One of ordinary skill in the art will recognize that Moiré interference is the perception of patterns caused by overlapping images that are not part of the images themselves. In one or more embodiments of the present invention, Moiré interference may be used in this manner to provide a visual indication of alignment accuracy between Moiré interference pattern 800 and inverted Moiré interference pattern 820 (and the corresponding transparent substrates and conductive patterns, if any). The Moiré interference generated indicates that the center of Moiré interference pattern 800 is not aligned to the center of inverted Moiré interference pattern 820.

Continuing in FIG. 9C, Moiré interference pattern 800 substantially overlaps inverted Moiré interference pattern 820. While closer to alignment, the center of Moiré interference pattern 800 is still not aligned to the center of inverted Moiré interference pattern 820. The substantial overlap of Moiré interference pattern 800 and inverted Moiré interference pattern 820 generates Moiré interference that may be visually apparent. In this instance, the Moiré interference includes what appears to be an arrowhead effect that tends to point towards the centers of the patterns. The arrowhead effect may indicate a vector for further alignment in applications or designs that use automation. The Moiré interference generated indicates that the center of Moiré interference pattern 800 is not aligned to the center of inverted Moiré interference pattern 820.

Continuing in FIG. 9D, Moiré interference pattern 800 overlaps and is center-aligned to inverted Moiré interference pattern 820. Because the center of Moiré interference pattern 800 is aligned to the center of inverted Moiré interference pattern 820, the combination of overlapping Moiré interference pattern 800 and inverted Moiré interference pattern 820 form an opaque circle that does not exhibit Moiré interference. The lack of Moiré interference indicates that Moiré interference pattern 800 overlaps and is center-aligned to inverted Moiré interference pattern 820.

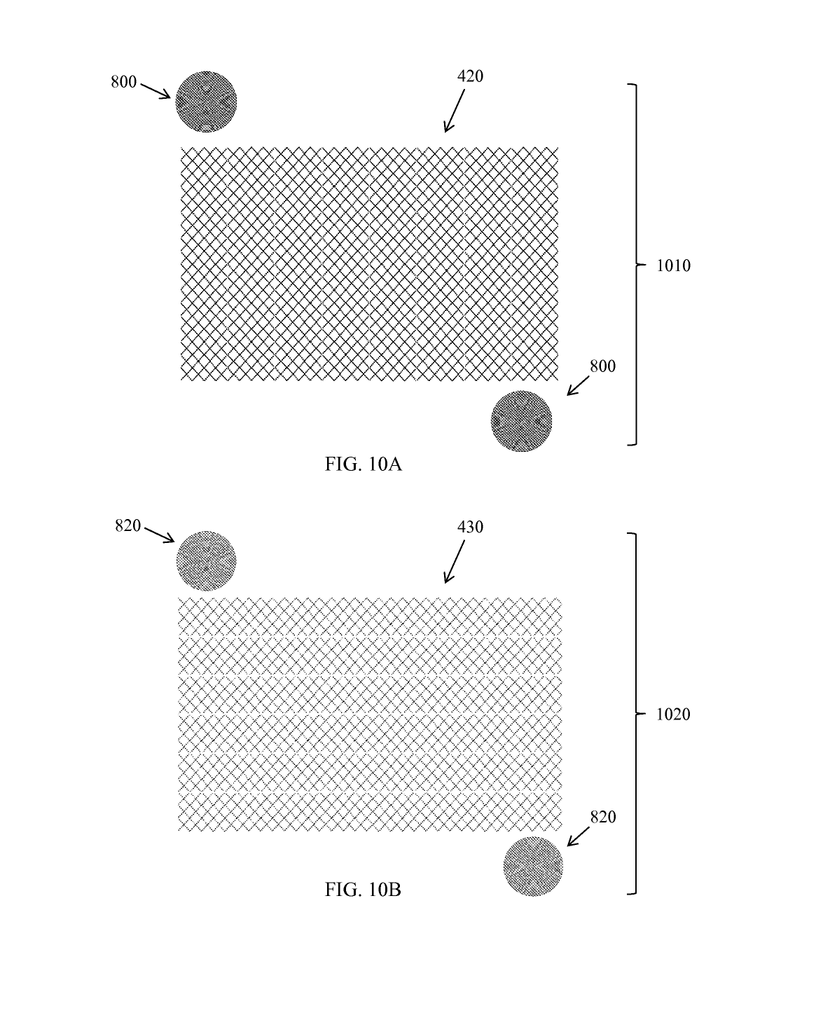

FIG. 10A shows a first conductive pattern 420 and a plurality of Moiré interference patterns 800 disposed on a first transparent substrate (e.g., transparent substrate 410) in accordance with one or more embodiments of the present invention. The plurality of Moiré interference patterns 800 are disposed on the first transparent substrate such that, when overlapping and center-aligned to a plurality of inverted Moiré interference patterns 820 disposed on a second transparent substrate (e.g., transparent substrate 410), the first conductive pattern 420 is aligned to the second conductive pattern 430 at a predetermined alignment that may include a predetermined offset. One of ordinary skill in the art will recognize that the predetermined offset may vary based on an application or design in accordance with one or more embodiments of the present invention. In certain embodiments, a first Moiré interference pattern 800 may be disposed on a top left corner of the first transparent substrate and a second Moiré interference pattern 800 may be disposed on a bottom right corner of the first transparent substrate to facilitate alignment. In this way, Moiré interference patterns 800 are disposed on opposing sides and opposing longitudinal ends of the first conductive pattern 420. One of ordinary skill in the art will recognize that the number, type, and placement of Moiré interference patterns 800 may vary based on an application or design in accordance with one or more embodiments of the present invention. In subsequent figures, first conductive pattern 420 and the plurality of Moiré interference patterns 800 disposed on the first transparent substrate may be referred to as substrate 1010.

Continuing in FIG. 10B, a second conductive pattern 430 and a plurality of inverted Moiré interference patterns 820 may be disposed on the second transparent substrate (e.g., transparent substrate 410). The plurality of inverted Moiré interference patterns 820 are disposed on the second transparent substrate such that, when overlapped by and center-aligned to Moiré interference patterns 800, the first conductive pattern 420 is aligned to the second conductive pattern 430 at the predetermined alignment that may include the predetermined offset. In certain embodiments, a first inverted Moiré interference pattern 820 may be disposed on a top left corner of the second transparent substrate and a second inverted Moiré interference pattern 820 may be disposed on a bottom right corner of the second transparent substrate to facilitate alignment. One of ordinary skill in the art will recognize that the number, type, and placement of inverted Moiré interference patterns 820 may vary based on an application or design in accordance with one or more embodiments of the present invention. In subsequent figures, second conductive pattern 430 and the plurality of inverted Moiré interference patterns 820 disposed on the second transparent substrate (410 of FIG. 4) may be referred to as substrate 1020.

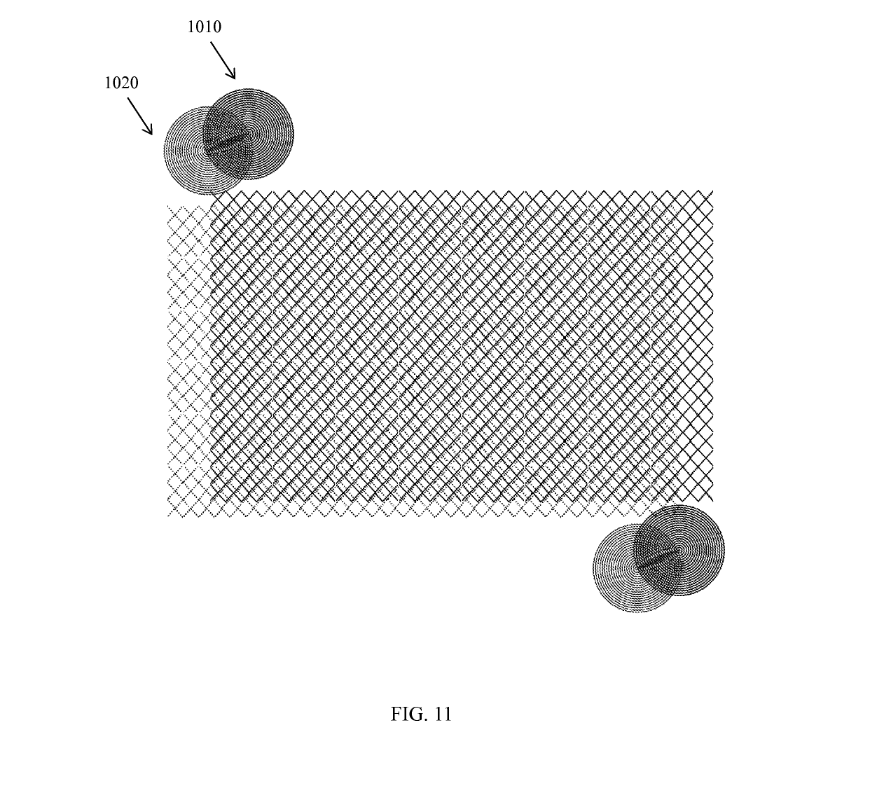

Continuing in FIG. 11, substrate 1010 is moved partially into place as part of an alignment process prior to lamination, bonding, or air gap placement of substrates 1010 and 1020. Substrate 1010 partially overlaps, but is not aligned to substrate 1020. Substrate 1010 may be misaligned horizontally and/or vertically. Because the Moiré interference patterns (800 of FIG. 10A) are not center-aligned to the inverted Moiré interference patterns (820 of FIG. 10B), Moiré interference may be visually apparent and indicate misalignment of the substrates. Further alignment may be necessary to properly align the first conductive pattern (420 of FIG. 10A) to the second conductive pattern (430 of FIG. 10B) at the predetermined offset. The interference pattern may assist in correcting the misalignment.

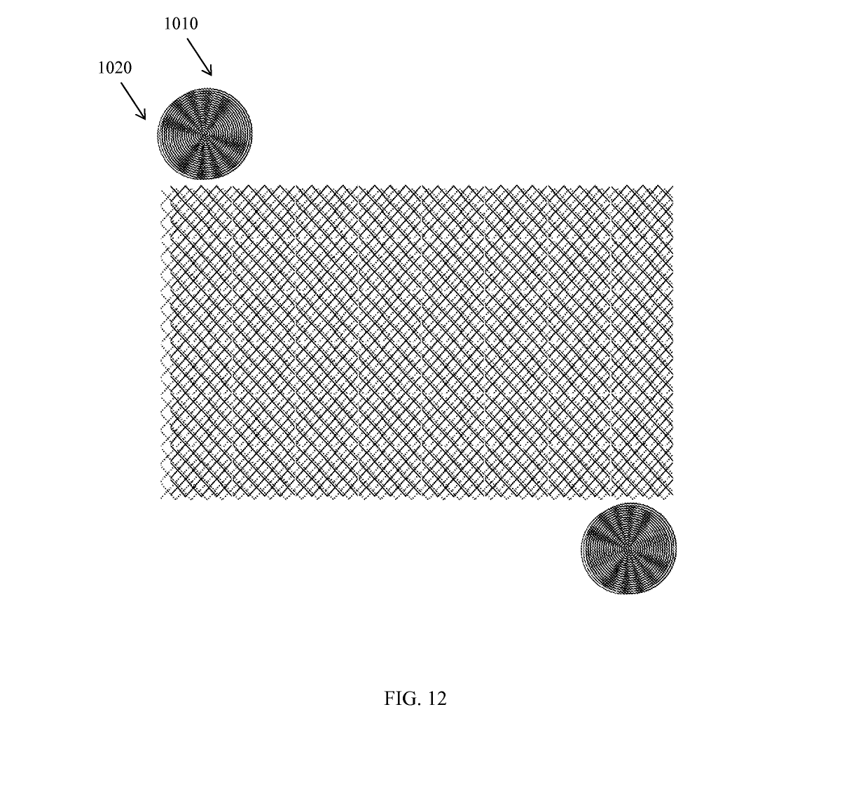

Continuing in FIG. 12, substrate 1010 is moved closer to alignment and substantially overlaps substrate 1020. Because the Moiré interference patterns (800 of FIG. 10A) are not center-aligned to the inverted Moiré interference patterns (820 of FIG. 10B), Moiré interference may be visually apparent and indicate misalignment of the substrates. Further alignment may be necessary to properly align the first conductive pattern (420 of FIG. 10A) to the second conductive pattern (430 of FIG. 10B) at the predetermined offset. The interference pattern may assist in correcting the misalignment.

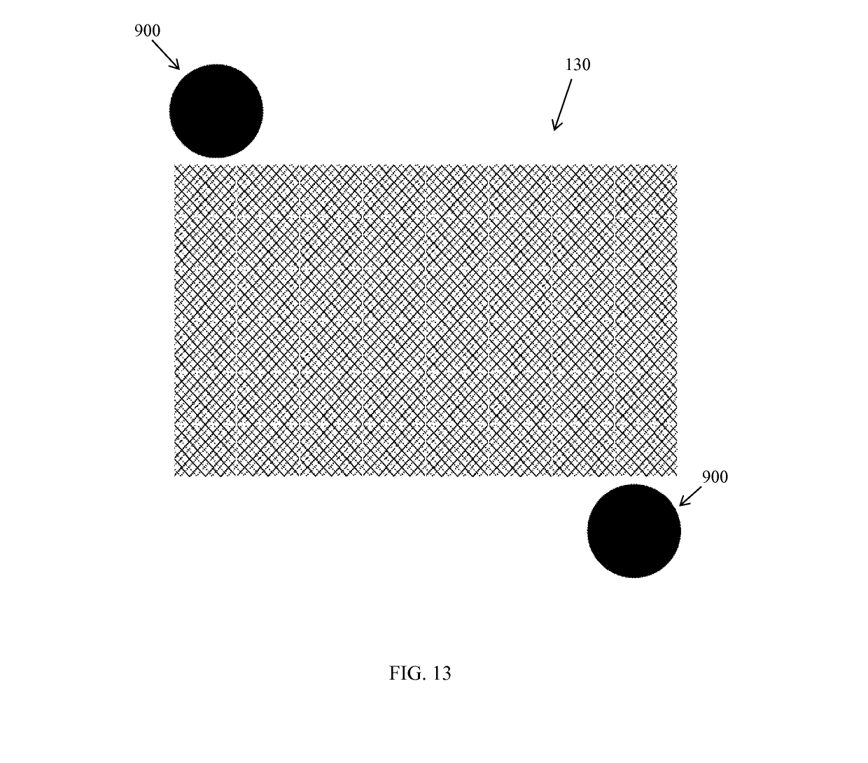

Continuing in FIG. 13, substrate 1010 is aligned to substrate 1020. Because the Moiré interference patterns (800 of FIG. 10A) are overlapping and center-aligned to the inverted Moiré interference patterns (820 of FIG. 10B), the overlapping region appears as an opaque circle and does not exhibit Moiré interference. The lack of Moiré interference indicates that substrate 1010 is aligned to substrate 1020 and the first conductive pattern (420 of FIG. 10A) is aligned to the second conductive pattern (430 of FIG. 10B) at the predetermined alignment that may include the predetermined offset. Substrate 1010 may be laminated, bonded, or secured in place for air gap placement.

One of ordinary skill in the art will recognize that the role played by Moiré interference patterns (800 of FIG. 10A) and inverted Moiré interference patterns (820 of FIG. 10B) may be reversed in accordance with one or more embodiments of the present invention. One of ordinary skill in the art will recognize that the same process may be used in embodiments that do not include conductive patterns to facilitate the alignment of transparent substrates.

FIG. 14A shows a Moiré interference pattern and an inverted Moiré interference pattern that do not overlap in accordance with one or more embodiments of the present invention. Moiré interference pattern 1410 may be disposed on a transparent substrate (e.g., transparent substrate 410) using the same process or processes used to dispose a conductive pattern (420 or 430 of FIG. 7) on the transparent substrate (e.g., transparent substrate 410). In certain embodiments, Moiré interference pattern 1410 may be a plurality of concentric circles that are opaque and cropped to a predetermined shape. In the example depicted, the plurality of concentric circles are cropped to a rectangular or square shape. Moiré interference pattern 1410 may be constructed using, for example, the same process set forth above with respect to FIG. 8A and then cropping the resulting pattern according to a predetermined shape. Inverted Moiré interference pattern 1420 may be disposed on a transparent substrate (e.g., transparent substrate 410) using the same process or processes used to dispose a conductive pattern (420 or 430 of FIG. 7) on the transparent substrate (e.g., transparent substrate 410). Inverted Moiré interference pattern 1420 may be an inverted image of the corresponding Moiré interference pattern 1410. One of ordinary skill in the art will recognize that any other shape(s) or pattern(s) capable of interfering may be used in accordance with one or more embodiments of the present invention.

FIG. 14B shows a Moiré interference pattern that partially overlaps an inverted Moiré interference pattern in accordance with one or more embodiments of the present invention. However, a center of Moiré interference pattern 1410 is not aligned to a center of inverted Moiré interference pattern 1420. Because Moiré interference pattern 1410 is not center-aligned to inverted Moiré interference pattern 1420, Moiré interference may be visually apparent. In this instance, the Moiré interference includes what appears to be an arrowhead effect that tends to point towards the centers of the patterns. The arrowhead effect may indicate a vector for further alignment in applications or designs that use automation. One of ordinary skill in the art will recognize that Moiré interference is the perception of patterns caused by overlapping images that are not part of the images themselves. In one or more embodiments of the present invention, Moiré interference may be used in this manner to provide a visual indication of alignment accuracy between Moiré interference pattern 1410 and inverted Moiré interference pattern 1420 (and the corresponding transparent substrates and conductive patterns, if any). The Moiré interference generated indicates that the center of Moiré interference pattern 1410 is not aligned to the center of inverted Moiré interference pattern 1420.

FIG. 14C shows a Moiré interference pattern that substantially overlaps an inverted Moiré interference pattern in accordance with one or more embodiments of the present invention. While closer to alignment, the center of Moiré interference pattern 1410 is still not aligned to the center of inverted Moiré interference pattern 1420. The substantial overlap of Moiré interference pattern 1410 and inverted Moiré interference pattern 1420 generates Moiré interference that may be visually apparent. In this instance, the Moiré interference includes what appears to be an arrowhead effect that tends to point towards the centers of the patterns. The arrowhead effect may indicate a vector for further alignment in applications or designs that use automation. The Moiré interference generated indicates that the center of Moiré interference pattern 1410 is not aligned to the center of inverted Moiré interference pattern 1420.

FIG. 14D shows a Moiré interference pattern that overlaps and is center-aligned to an inverted Moiré interference pattern in accordance with one or more embodiments of the present invention. Because the center of Moiré interference pattern 1410 is aligned to the center of inverted Moiré interference pattern 1420, the combination of overlapping Moiré interference pattern 1410 and inverted Moiré interference pattern 1420 form an opaque rectangle or square 1430 that does not exhibit Moiré interference. The lack of Moiré interference indicates that Moiré interference pattern 1410 overlaps and is center-aligned to inverted Moiré interference pattern 1420.

Advantages of one or more embodiments of the present invention may include one or more of the following:

In one or more embodiments of the present invention, a method of aligning transparent substrates provides for simple, efficient, and cost-effective visual alignment of transparent substrates.

In one or more embodiments of the present invention, a method of aligning transparent substrates provides for accurate and precise alignment of transparent substrates prior to lamination, bonding, or air gap placement.

In one or more embodiments of the present invention, a method of aligning transparent substrates ensures that a first conductive pattern disposed on a first transparent substrate is aligned to a second conductive pattern disposed on a second transparent substrate at a predetermined offset includes the option of no offset.

In one or more embodiments of the present invention, a method of aligning transparent substrates uses Moiré interference patterns and inverted Moiré interference patterns that are electrically isolated, or otherwise not connected to, the conductive patterns.

In one or more embodiments of the present invention, a method of aligning transparent substrates uses Moiré interference patterns and inverted Moiré interference patterns that may be formed using the same process or processes used to form the conductive patterns.

In one or more embodiments of the present invention, a method of aligning transparent substrates is compatible with existing flexographic printing processes used to form conductive patterns on the transparent substrates.

In one or more embodiments of the present invention, a method of aligning transparent substrates is compatible with other existing conductive pattern fabrication processes used to form conductive patterns on the transparent substrates.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of aligning transparent substrates comprising:
disposing one or more Moiré interference patterns on a side of a first transparent substrate;
disposing one or more inverted Moiré interference patterns on a side of a second transparent substrate; and
aligning the first transparent substrate to the second transparent substrate using Moiré interference,
wherein each Moiré interference pattern is center-aligned to a corresponding inverted Moiré interference pattern.

2. The method of claim 1, further comprising:
bonding the first transparent substrate to the second transparent substrate.

3. The method of claim 2, wherein the first transparent substrate is bonded to the second transparent substrate by a lamination process.

4. The method of claim 2, wherein the first transparent substrate is bonded to the second transparent substrate by an optically clear adhesive.

5. The method of claim 2, wherein the first transparent substrate is bonded to the second transparent substrate by an optically clear resin.

6. The method of claim 2, wherein the first transparent substrate is bonded to the second transparent substrate with an air gap disposed between them.

7. The method of claim 1, wherein each Moiré interference pattern comprises a plurality of concentric circles and each corresponding inverted Moiré interference pattern comprises an inverse image of the Moiré interference pattern.

8. The method of claim 1, wherein, when a corresponding pair of a Moiré interference pattern and an inverted Moiré interference pattern overlap and are not center-aligned, the patterns interfere producing Moiré interference that visually indicates the centers of the patterns.

9. A method of aligning conductive patterns disposed on transparent substrates comprising:
disposing a first conductive pattern and one or more Moiré interference patterns on a side of a first transparent substrate;
disposing a second conductive pattern and one or more inverted Moiré interference patterns on a side of a second transparent substrate; and
aligning the first transparent substrate to the second transparent substrate using Moiré interference,
wherein each Moiré interference pattern is center-aligned to a corresponding inverted Moiré interference pattern.

10. The method of claim 9, further comprising:
bonding the first transparent substrate to the second transparent substrate.

11. The method of claim 10, wherein the first transparent substrate is bonded to the second transparent substrate by a lamination process.

12. The method of claim 10, wherein the first transparent substrate is bonded to the second transparent substrate by an optically clear adhesive.

13. The method of claim 10, wherein the first transparent substrate is bonded to the second transparent substrate by an optically clear resin.

14. The method of claim 10, wherein the first transparent substrate is bonded to the second transparent substrate with an air gap disposed between them.

15. The method of claim 9, wherein each Moiré interference pattern comprises a plurality of concentric circles and each corresponding inverted Moiré interference pattern comprises an inverse image of the Moiré interference pattern.

16. The method of claim 9, wherein, when a corresponding pair of a Moiré interference pattern and an inverted Moiré interference pattern overlap and are not center-aligned, the patterns interfere producing Moiré interference that visually indicates the centers of the patterns.

17. The method of claim 9, wherein the plurality of Moiré interference patterns are disposed on the first transparent substrate and the plurality of inverted Moiré interference patterns are disposed on the second transparent substrate such that the first conductive pattern is aligned to the second conductive pattern at a predetermined alignment.

18. The method of claim 9, wherein the plurality of Moiré interference patterns are disposed on the first transparent substrate and the plurality of inverted Moiré interference patterns are disposed on the second transparent substrate such that the first conductive pattern is aligned to the second conductive pattern at a predetermined alignment that includes a predetermined offset.

19. The method of claim 9, wherein the first transparent substrate is aligned to the second transparent substrate such that the first conductive pattern is aligned to the second conductive pattern at a predetermined alignment.

20. The method of claim 9, wherein the first transparent substrate is aligned to the second transparent substrate such that the first conductive pattern is aligned to the second conductive pattern at a predetermined alignment that includes a predetermined offset.
